(19) United States
(12) Patent Application Publication
(10) Pub. No.: US 2013/0066450 A1
(43) Pub. Date: Mar. 14, 2013

(54) DEVICE FOR REMOVING A PROTECTIVE FILM OFF A SHEET AND THE RELATED PROCESS FOR AUTOMATIC READING OF THE TICKET'S DATA

(71) Applicant: Rolando Wyss, Vaduz (LI)

(72) Inventor: Rolando Wyss, Vaduz (LI)

(21) Appl. No.: 13/698,275

(22) PCT Filed: May 18, 2011
(86) PCT No.: PCT/IB11/01074

§ 371 Date: Nov. 15, 2012

(30) Foreign Application Priority Data
May 27, 2010 (CH) 00837/10

(51) Int. Cl. A63F 9/24; B32B 38/10

(52) U.S. Cl. CPC A63F 9/24; B32B 38/10
USPC 700/91; 156/750

(57) ABSTRACT

In a device for removing a protective film off a sheet such as game tickets or the like is described. The device has scraping means of the protective film and drawing means of the sheet, together with automatic reading means from which a winning ticket can be detected. The device also includes a recognition unit of the data read by the automatic reading means and warning or displaying means to signal or visualize information relating to a possible win of the ticket.

The present invention relates to a device for removing a protective film off a sheet such as game tickets for example scratch tickets or the like.

The device also relates to the related process in order to remove the protective film off a sheet of the just mentioned kind.

In the following, merely for illustrative purposes, we will refer to the tickets of the above mentioned kind but this should not be construed as a limitation of the scope of the present invention.

As known, after buying tickets such as scratch tickets, it is necessary to remove the film which partially covers them in order to see if the ticket is a winning one or not. This operation can be done manually, but in order to quickly remove or eliminate the protective film or paint, devices comprising a removal or scraping roll opposite to a drawing or pulling roll, both motorized, are used.

The scraping roll, appropriately corrugated, has the specific purpose of removing the film, while the drawing roll has the function, together with the scraping roll, to draw the ticket so that the whole ticket passes between the scraping roll and the drawing roll.

Whatever is the method of scraping the tickets, manual or motorized, it is necessary, after the removal of the protective film, to see if the ticket is a winning one or not and, if it is a winning one, to know the amount of the prize.

From the information, or more precisely, from the representations or pictures emerged once the protective film has been removed, you can determine if the ticket is a winning ticket.

However, often and frequently, you are not able to determine the amount of the prize and, anyway, for the confirmation of the winnings it is necessary to contact the administrator of the game.

In this case, it is necessary to temporarily hand over the ticket to the retailer where the ticket was purchased, such as a tobacconist's or a lottery office which have to contact the administrator of the game communicating both the identifying code of the ticket and the information that has appeared after the removal of the protective film. The administrator checks if the ticket is actually a winning ticket and, if so, determines the amount of the prize. At this point, the administrator informs the retailer if the ticket is a winning ticket or not, and if it is a winning one, he communicates also the amount of the prize.

It is obvious that these operations are rather long and laborious and a long time can pass from the time the ticket has been scraped and the time when you become aware of the amount of the possible prize.

Moreover, in case the scraping operation takes place manually, one can easily realize that this time is significantly longer.

All this limits the sales of tickets and many buyers or players, who would buy tickets, renounce to purchase tickets, either because they have no time to wait, or because they simply do not want to wait impatiently for the response from the administrator. It must also to be considered the problem that often the winnings are not collected. As described above, after having removed the protective film, the player has to check if the card or ticket is a winning one, but this check is difficult, complex and time consuming.

The problem increases for certain people, such as the elderly. In fact, they have to memorize and compare a series of winning numbers or signs with all the numbers or signs written on the ticket.

Furthermore, the player often makes a mistake in comparing, or he forgets to collect the prize and maybe he throws away the ticket thus making impossible to collect the prize even in the future.

The problem of the not collected winnings is widespread in this game and many other lottery games.

The aim of this invention is therefore to shorten the time required from the purchase of the ticket and the time when you are informed by the administrator if the purchased ticket is a winning one and what the amount of the prize is.

Another aim is to remarkably increase the ticket sales by reducing or, even nearly eliminating, the time which passes from the purchase to the time when you become aware of the possible win, so as to make the game an instantaneous one, as for example, it occurs for any casino game in which you are immediately informed of the possible win.

These aims are achieved by a device for removing a protective film off a sheet such as game tickets or the like, comprising removal or scraping means of said protective film and drawing or pulling means of said sheet, characterized in that said device is provided with automatic reading means of data contained on this sheet from which is deduced if the ticket is a winning one.

Preferably, the device comprises warning or displaying means of the possible ticket's win.

The warning means can be either sound or visual.

In this way, the removal occurs mechanically so the time required to remove the film is rather short. In addition, the ticket is read automatically by the reading means which are able to quickly read the data from which is deduced if the ticket is a winning one or not and, if so, the amount of the prize.

If there is also a displaying unit or a display it is possible to visualize information concerning the win.

The time required to determine if the ticket is a winning one is short and, in case it is a winning one, the to determine the prize is also short.

Consequently, the player is encouraged to purchase game tickets as the waiting time for the outcome is very short.

In addition, if the player fails to win, is also motivated to try again and then to buy other tickets with the prospect that sooner or later he will buy a winning ticket. Indeed, it is well known in the field of casino games that an eagerness could arise in the player, when players invest large amounts of money with the hope to recover the losses suffered.

In other words, from a simple game which involves the purchase of a ticket or some tickets to be scraped as an end in itself as if it is the purchase of game tickets, the game becomes like a casino game where you continue to play in an attempt to reach the coveted prize.

It is therefore clear the potential for such a device which allows to increase enormously the number of potential players, but above all the amount of money each player is willing or not willing to spend.

It has also to be considered that the problem related to the unclaimed winnings is definitely resolved. In fact, thanks to this new device, the problem is finally solved because the player, passing the ticket or the card into the device almost immediately sees on the display if he has won and, if so, also sees the relevant prize.

The above-mentioned aims are also achieved by a process for removing or scraping a protective film off a sheet such as game tickets or the like, characterized in that it comprises the following steps:
a) a first step of removal or scraping of the protective film off a sheet using a device
b) a second step of automatic reading the data contained on this sheet
c) a third step of processing for the recognition of the read data
d) a fourth step of data processing to determine the possible ticket's win
e) a fifth step of signaling the possible win or displaying information relating to the possible win by warning or displaying means associated with said device.

Preferably, between the step c) and step d), the process comprises a further step of to transmitting the data to a data processing center or computer where the step d) of the data processing occurs to determine the possible win of the ticket, and between step d) and step e), there is a further step of transmitting information relating to the possible win of the ticket from said data processing center or computer to said warning or displaying means which visualize the possible ticket's win.

These and other advantages of the present invention will result more apparent from the following detailed embodiments provided only for illustrative but not limitative purposes with reference to the following drawings in which:

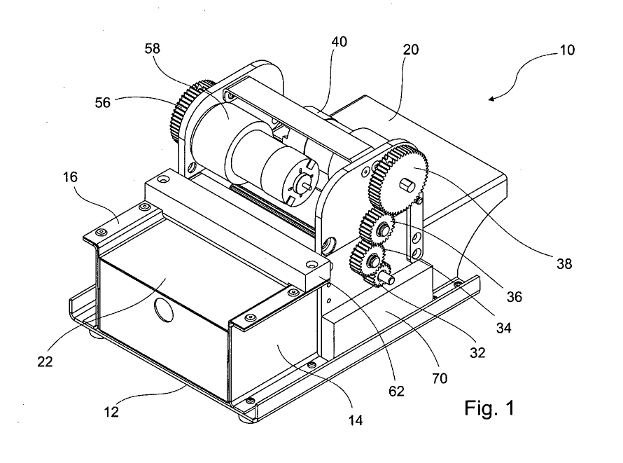

FIG. 1 is a perspective view of a device for scraping tickets according to the present invention;

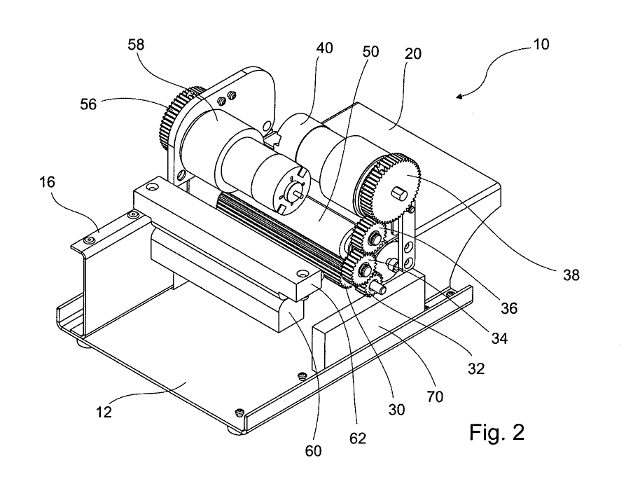

FIG. 2 is a perspective view, similar to that of FIG. 1, wherein some parts of the device have been removed;

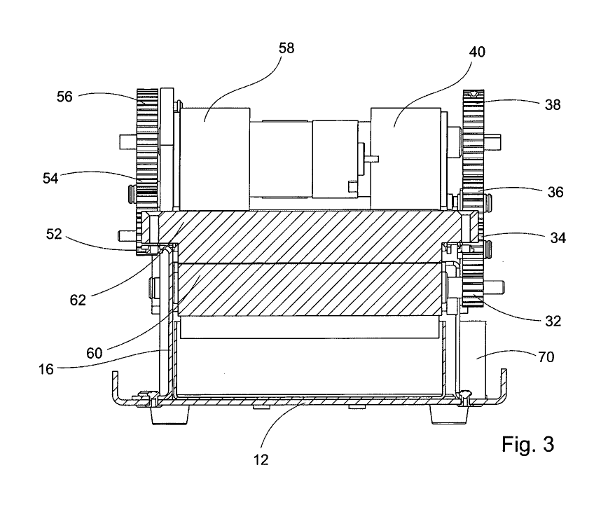

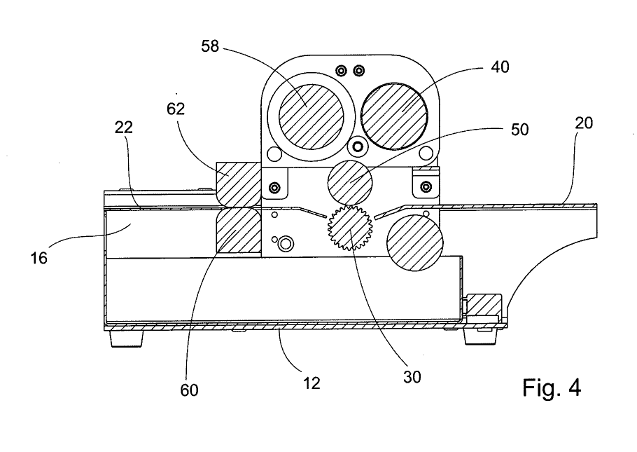

FIGS. 3 and 4 are two vertical sections, respectively transverse and longitudinal ones, of the device of FIG. 1;

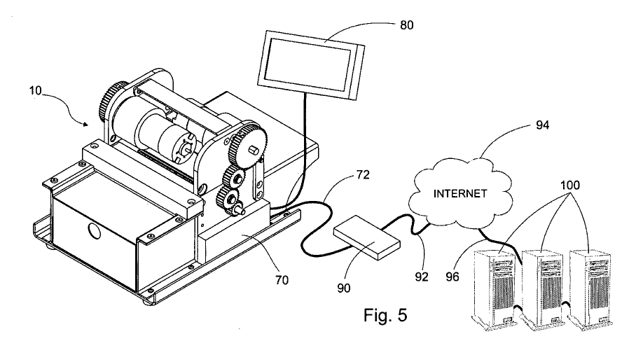

FIGS. 5, 6, 7 and 8 are perspective views of a device of the invention which illustrate some of its embodiments;

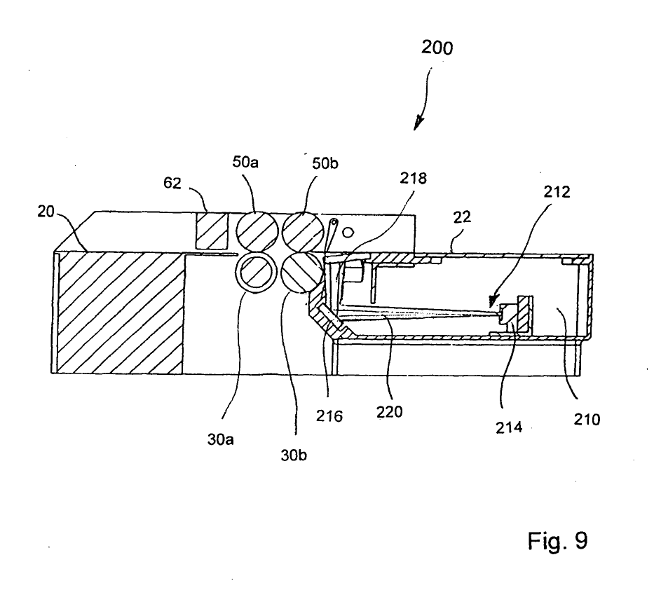

FIG. 9 is a vertical cross section of a device according to a variant of the present invention.

FIGS. 1 and 2 show a device 10 for removing a protective film off a sheet such as a ticket (for example a scratch ticket), a coupon, a card, or others.

The device 10 comprises a base 12 and two vertical side walls 14,16 parallel and opposite to each other.

A removal or scraping roll 30 of a protective film off a sheet and a drawing or pulling roll 50 are positioned over the scraping roll 30 and extend between the two side walls 14,16.

The scraping roll 30 and the drawing roll 50 are then placed opposite and spaced apart from each other to an extent to allow the passage of the ticket and, at the same time, allowing the drawing roll 50 to draw the ticket, and that the scraping roll 30, pressing against the drawing roll 50, can remove the film that covers the tickets.

As can be seen in FIGS. 1, 2 and 3, the scraping roll 30 is coupled to a pinion 32 which meshes with a first gear wheel 34 which in turn meshes with a second gear wheel 36 and, in turn, meshes with a pinion 38 coupled to an electric motor 40 for driving the scraping roll 30.

The electric motor 40 and the gear wheels 34,36,38 form a first motorization for rotating the scraping roll 30.

The drawing roll 50 is instead coupled to a pinion 52 which meshes with a gear wheel 54 which, in turn, meshes with a pinion 56 coupled to an electric motor 58 for driving the drawing roll 50 (see FIG. 3).

The electric motor 58 and the gear wheels 54,56 form a second motorization for rotating the drawing roll 50.

From FIGS. 1, 2 and 4, we note that a first support plate 20 for the ticket to be scraped is positioned in front of the scraping roll 30 and the drawing roll 50.

Whereas, a second support plate 22 for the scratched ticket coming out of the device 10 is positioned behind the scraping roll 30 and the drawing roll 50.

From FIGS. 2 and 4, we note that a first reader or scanner 60, able to read the data contained on the lower side of the sheet from which the protective film has been removed, is positioned underneath the second support plate 22.

While, a second reader or scanner 62, able to read the data contained on the upper side of the sheet, is positioned above the second support plate 22.

The first and second reader 60, 62 preferably extend for the entire distance between the two vertical side walls 14, 16 so as to be able to read the data contained on the sheet of any size which passes between the scraping roll 30 and the drawing roll 50.

The first and second reader 60,62 may be optical readers with a matrix or linear geometry sensor and, moreover, may be in contact or spaced apart from the surface of the ticket to be read.

As it is well known, scratch tickets contain identifying data of the ticket which are clearly visible and also hidden, namely they are covered by a protective film and indicates whether the ticket is a winning one or not and, in the first case, they also determine the amount of the prize.

The operation of the device 10 occurs in the following mode.

First, both the electric motor 40 of the motorization for the scraping roll 30 and the electric motor 58 of the motorization for the drawing roll 50 are started. Then, a ticket is laid down on the first support plate 20 with the side containing the film to be removed downwards and it is pushed until it is inserted between the scraping roll 30 and drawing roll 50. The ticket is pulled by the drawing roll 50 and the protective film which covers the lower side of the ticket is removed by the scraping roll 30. The ticket comes out of the opposite side, i.e. on the second support plate 22 with the film completely removed.

The ticket passes between the scraping roll 30 and drawing roll 50, but also passes between the first and the second reader 60,62.

The first reader 60 reads the lower side of the ticket from which the protective film has been removed and, then, it can read the data relating to the possible win, while the second reader 62 reads the upper side of the ticket which is not affected by the scraping operation and it is therefore able to read the identifying data of the ticket.

From FIGS. 1 and 2, we note that the device 10 comprises a data recognition unit 70 for the recognition of data read by the first reader 60 and the second reader 62. More specifically, the data detected by the two readers 60 and 62 must be appropriately recognized by the unit 70, so that they can be further processed in order to determine the possible win, as illustrated below.

Preferably, the device 10 is provided with a displaying unit or display 80, connected to the data recognition unit 70, in order to display information relating to the possible win of the ticket, as can be seen from FIGS. 5, 6 and 8.

FIGS. 5, 6, 7 and 8 show the device 10 in different configurations of the possible use.

In particular, FIG. 5 illustrates a device 10, as described above but also comprising a transceiving unit 90 connected to the data recognition unit 70 by a first cable 72, and able to connect to a server or a data processing center 100 for the processing of the recognized data to determine if the ticket is a winning one. For this purpose, the transceiving unit 90 is connected, via a cable 92, to the Internet network 94, and the data processing center 100 is connected to the Internet network via a cable 96.

Thus, the data processing center 100 receives the recognized data from the transceiving unit 90 via the Internet network, processes them in order to determine the possible win, then transmits this information to the transceiving unit 90 and, then, this is visualized by the display 80.

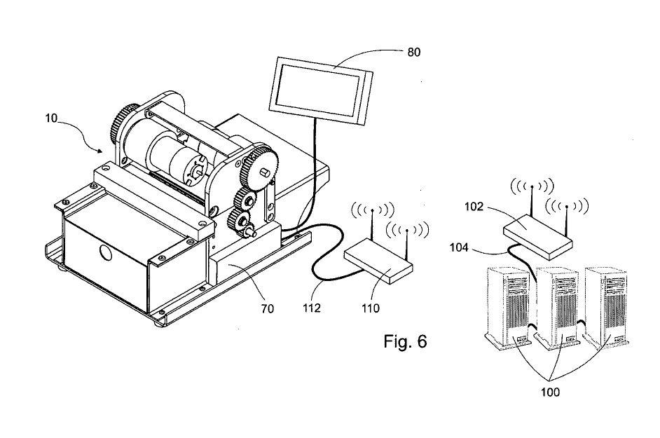

FIG. 6 shows a device 10 that, similarly to what has been described with reference to FIG. 5, is able to be connected to a data processing center 100, but in this case wirelessly. In particular, the device 10 comprises a wireless transmission unit 110, connected to the data recognition unit 70 via a cable 112, which is able to connect to a wireless transmission unit 102 connected to the data processing center 100 through a cable 104.

In this operational mode, the operation is similar to that described with reference to FIG. 5.

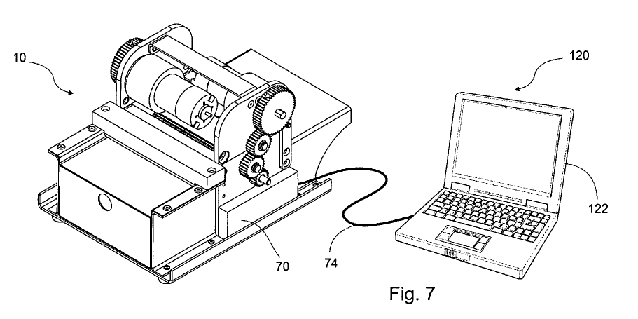

Instead, in FIG. 7, the data recognition unit 70 is directly connected to a computer 120, such as a laptop computer, via a cable 74.

In this case, the data recognition unit 70 transmits the recognized data to the computer 120 which processes them and, then, displays the result, i.e. the possible win, on the monitor 122.

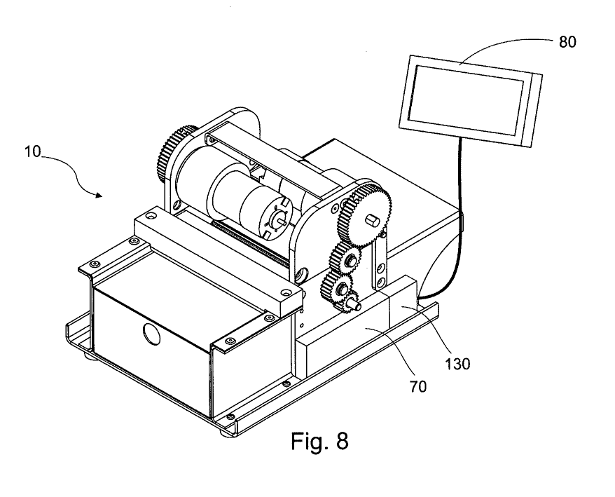

Finally, FIG. 8 shows a device 10 comprising a data processing unit 130 connected on one side to the data recognition unit 70 and, on the other side, connected to the display 80.

The data processing unit 130 has a hardware system onto which software containing information on tickets and winning combinations is loaded, and able to process the data coming from the data recognition unit 70 to determine the amount of the possible win and show it on the display 80.

In case new types of scratch tickets have been put on the market or the winning combinations or the amount of the winnings are changed or, in case of any change, it is sufficient to replace the software with a new updated software.

FIG. 9 shows a device 200 according to a variant of the present invention whose main differences compared to the previous device 10 will be described below.

The device 200 comprises a pair of scraping rolls 30a, 30b and a pair of drawing rolls 50a, 50b. Each scraping roll 30a, 30b is respectively opposite to each drawing roll 50a, 50b.

On the entry side, there is a first support plate 20 of the ticket to be scraped and, on the exit side, there is a second support plate 22 of the scraped ticket.

Below the second support plate 22 there is a compartment 210 which contains inside a reading system 212 of the data printed on the lower side of the just scraped ticket. The reading system 212 comprises a camera or video camera 214 and a mirror 216. The camera 214 is oriented horizontally towards the mirror 216 which is disposed essentially at 45° with respect to the horizontal, so that the image of the scraped ticket projects downwards, by the light beam 218, it is reflected in a horizontal beam 220 which comes to the camera 214 which is able to read the data printed on the ticket just scraped.

Thanks to the fact that the mirror 216 is oriented at 45°, it is possible to position the camera or videocamera 214 horizontally, so as to use optimally the space inside the compartment 210 to construct the necessary light path which must separate the camera or videocamera 214 from the ticket to be read. It is also possible to provide different optical paths through the use of appropriate lenses or mirrors.

In essence, the reading system 212 with camera or videocamera 214 replaces the former first reader or scanner 60 of the device 10.

The device 200, similarly to the device 10, is provided with the second reader or scanner 62, positioned on the entry side above the first support plate 20, for reading the data on the upper side of the ticket which is not scraped off.

It is understood that what has been described with respect to the device 10 also applies to the device 200, such as the motorization used for rotating the scraping and drawing rolls.

It is further obvious that any changes conceptually or functionally equivalent fall under the scope of the present invention.

For example, it is possible to provide other means of communication between the device 10 or 200 and the data processing center 100, such as by using the GSM or UMTS networks or other connecting methods, also a satellite connection.

It is also possible to provide readers positioned differently from that described above. For example, the second reader 62 which reads the upper side of the ticket where there is no protective film to be scraped, may be positioned on the entry side of the ticket rather than on the exit side.

Finally, the device can be provided with sound or sonorous means, such as a loudspeaker, able to communicate this information to the user or player, or it can be provided with a buzzer which simply warns of the win. In this case, the device is also provided with converting means able to convert the original information in sound or sonorous information.

The device can also be provided with a light signal, such as a intermittent lamp, able to alert the user of the win.

1. A Device for removing a protective film off a sheet, comprising
removal or scraping means of said protective film;
drawing or pulling means of said sheet; and
automatic reading means of data contained on the sheet, said automatic reading means allowing identification of a winning ticket in case said sheet is a game ticket.

2. The device according to claim 1, further comprising warning or displaying means, said warning or displaying means signaling a winning ticket in case said sheet is a game ticket.

3. The device according to claim 2, wherein said warning or displaying means comprises a displaying unit or display, said displaying unit or display to visualizing information relating to a possible win in case said sheet is a game ticket.

4. The device according to claim 2, wherein said warning or displaying means comprise sound means.

5. The device according to claim 2, wherein said warning or displaying means comprises visual or luminous means.

6. The device according to claim 1, wherein said automatic reading means comprise a first reader or scanner for reading the data on a first side of said sheet.

7. The device according to claim 1, wherein said automatic reading means comprise at least one camera or video camera for reading the data on a first side of said sheet.

8. The device according to claim 6, wherein said automatic reading means comprise a second reader or scanner for reading the data on a second side of said sheet.

9. The device according to claim 1, further comprising
a recognition unit of the data read by said automatic reading means.

10. The device according to claim 9, further comprising
warning or displaying means, said warning or displaying means signaling a winning ticket in case said sheet is a game ticket;
a transceiving unit, connected to said recognition unit, able to communicate the data received from said recognition unit to a data processing center, and to receive from said data processing center information relating to a possible win in case said sheet is a game ticket, said information being visualized or signalled by said warning or displaying means.

11. The device according to claim 9, further comprising warning or displaying means, said warning or displaying means signaling a winning ticket in case said sheet is a game ticket, wherein said recognition unit is configured to be connected to a computer so as to transmit the data recognized by said recognition unit to said computer, said computer being able to process the recognition data and determine a possible win in case said sheet is a game ticket.

12. The device according to claim 9, further comprising:
warning or displaying means, said warning or displaying means signaling a winning ticket in case said sheet is a game ticket;
a data processing unit connected to said recognition unit, said data processing unit being able to determine a possible win and visualize the possible win by said warning and displaying means in case said sheet is a game ticket.

13. The device according to claim 1, wherein
said removal or scraping means comprise at least one removal or scraping roll of said protective film, and
said drawing or pulling means comprise at least one drawing or pulling roll of said sheet opposite to said at least one scraping roll, said sheet passing between said at least one scraping roll and said at least one drawing roll.

14. A process for removing or scraping a protective film off a sheet comprising the steps of:
a) removing or scraping of the protective film off said sheet using a device;
b) automatically reading data contained on said sheet;
c) processing automatically read data for recognition of said automatically read data;
d) further processing to determine a possible win in case said sheet is a game ticket; and
e) signaling the possible win or displaying information relating to the possible win by warning or displaying means associated with said device.

15. The process according to claim 14, further comprising
a step, between step c) and step d), of transmitting the recognized data to a data processing center or computer where said step d) occurs, to determine the possible win, and
a step, between step d) and step e), of transmitting information relating to the possible win of the game ticket from said data processing center or computer to said warning or displaying means which visualize the possible win of the game ticket.

16. The process according to claim 14, wherein said step d) is performed by a data processing unit associated with said device.
